(19) United States
(12) Patent Application Publication
(10) Pub. No.: US 2002/0109308 A1
(43) Pub. Date: Aug. 15, 2002

(54) Rotary tool adapter

(76) Inventor: Sandy Ochoa, Alamogordo, NM (US)

Correspondence Address: William R. Sharp, P.O. Box 1306, Miami, OK, 74355-1306, US

(21) Appl. No.: 09/788,161

(22) Filed: Feb. 15, 2001

(51) Int. Cl. B23B 31/00

(52) U.S. Cl. 279/144

(57) ABSTRACT

A rotary tool adapter is described herein for an apparatus of the type having a tubular wand with opposing first and second ends, a power head connected to the first wand end, and a drive shaft rotatable by and extending from the power head through the wand to a shaft end portion adjacent to the second wand end, wherein the adapter comprises: a tubular housing having opposing first and second free ends, the first housing end being receivable over the second wand end such that a portion of the wand adjacent to the second wand end extends at least partially into the housing; a mechanism for removably securing the housing to the wand; at least one substantially annular bearing mounted within the housing; and an arbor having a socket end portion and an opposing threaded end portion, the arbor being received through and mounted in the bearing(s) so as to be coaxially rotatable with respect to the housing and extend from the socket end portion within the housing to the threaded end portion outside the housing but adjacent to the second housing end. The socket end portion is adapted to drivingly mate with the shaft end portion and the threaded end portion is capable of threadedly receiving thereon a rotary tool having a threaded arbor hole sized to receive the threaded end portion.

### BACKGROUND OF THE INVENTION

The invention relates to a rotary tool adapter for an apparatus of the type having a tubular wand, a power head connected to one end of the wand, and a drive shaft extending through the wand from the power head to the other end of the wand.

The above-mentioned apparatus is widely available in the form of a weed and grass trimmer having a rotary cutter head driven by the drive shaft. The cutter head is typically removably connected to the wand by various means using screws and/or bolts, and includes the well known monofilament line that rotates at a high speed to cut the weeds or grass. It would be highly desirable if the trimmer could be adapted for use with rotary tools other than the cutter head.

### SUMMARY OF THE INVENTION

It is, therefore, an object of the invention to provide an adapter for an apparatus such as a grass and weed trimmer, which enables the use of any desired rotary tool once the cutter head is removed from the wand.

The above object is realized by a rotary tool adapter for an apparatus of the type having a tubular wand with opposing first and second ends, a power head connected to the first wand end, and a drive shaft rotatable by and extending from the power head through the wand to a shaft end portion adjacent to the second wand end, wherein the adapter comprises: a tubular housing having opposing first and second free ends, the first housing end being receivable over the second wand end such that a portion of the wand adjacent to the second wand end extends at least partially into the housing; a means for removably securing the housing to the wand; a substantially annular bearing means mounted within the housing; and an arbor having a socket end portion and an opposing threaded end portion, the arbor being received through and mounted in the bearing means so as to be coaxially rotatable with respect to the housing and extend from the socket end portion within the housing to the threaded end portion outside the housing but adjacent to the second housing end. The socket end portion is adapted to drivingly mate with the shaft end portion and the threaded end portion is capable of threadedly receiving thereon a rotary tool having a threaded arbor hole sized to receive the threaded end portion.

Rotary tools having arbor holes are commercially available from various manufacturers. Such rotary tools include brushes, sanding disks, buffer pads, etc. By using the adapter of the invention with one of these tools after removal of the cutter head, a weed and grass trimmer common to most households can be easily converted for effective use in a variety of situations other than lawn care, including: construction cleanup, floor repairs, outdoor decks, swimming pool grout, outdoor tile, boat hulls, and virtually anywhere rotary tools are used. Since the adapter and its associated rotary tool are connected to one end of an elongated wand, use of the rotary tool is easy and convenient. For example, with a rotary brush or sanding tool, it is possible for the operator to remove loose paint from the eaves of a house without the use of a ladder. Or, sanding or buffing a floor can be easily performed without bending or kneeling. In addition, the power head that rotates the drive shaft and rotary tool is usually controllable by the operator with regard to speed, thereby providing optimum control of the rotary tool for any desired application.

### BRIEF DESCRIPTION OF THE DRAWINGS

FIG. 1 is an exploded view of one embodiment of the rotary tool adapter.

FIG. 2 is a longitudinal cross-sectional view of the fully assembled rotary tool adapter.

FIG. 3 is a view of the an arbor in the rotary tool adapter as viewed along line 3-3 in FIG. 2.

FIGS. 4 and 5 show the adapter and associated rotary tools connected to wands of the above-mentioned type of apparatus.

### DESCRIPTION OF A PREFERRED EMBODIMENT

In the following description of a preferred embodiment of the rotary tool adapter, the terms “upper” and “lower” are used for the sake of convenience, although it should be understood that the adapter can assume other orientations than the one shown.

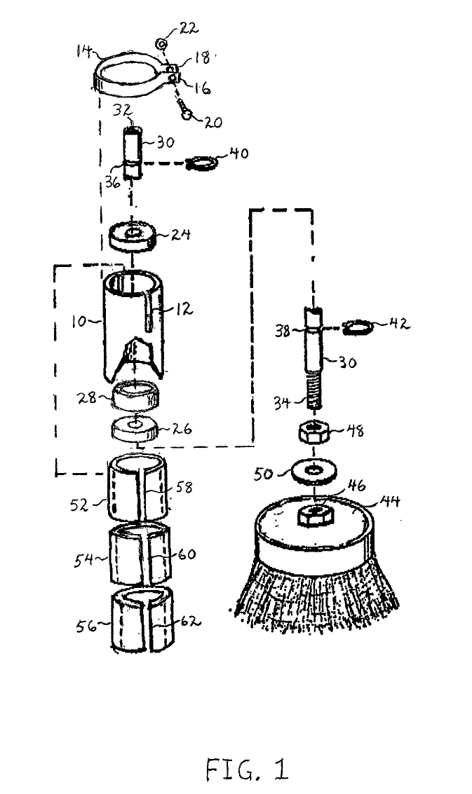

Referring to FIG. 1, tubular housing 10 has opposing upper and lower free ends, as well as diametrically opposed slots 12 that longitudinally extend from the upper end of the housing. Each slot 12 preferably extends at least about a third of the length of housing 10. One of the slots is only partially visible in FIG. 1. A “C” clamp 14, having opposing ears 16 and 18 with aligned holes, is sized to be receivable over the exterior of housing 10. A bolt 20 can be received through the holes in ears 16 and 18 for threaded engagement with a nut 22. Bearings 24 and 26, as are spaceable from one another by tubular spacer 28, have an outside diameter that allows them to be press fit within housing 10. Bearings 24 and 26 are substantially annular in shape, and are preferably sealed ball bearings (for which the ball elements are not visible in FIG. 1) which have an RPM rating at least twice that of the maximum RPM of arbor 30 for optimum bearing performance.

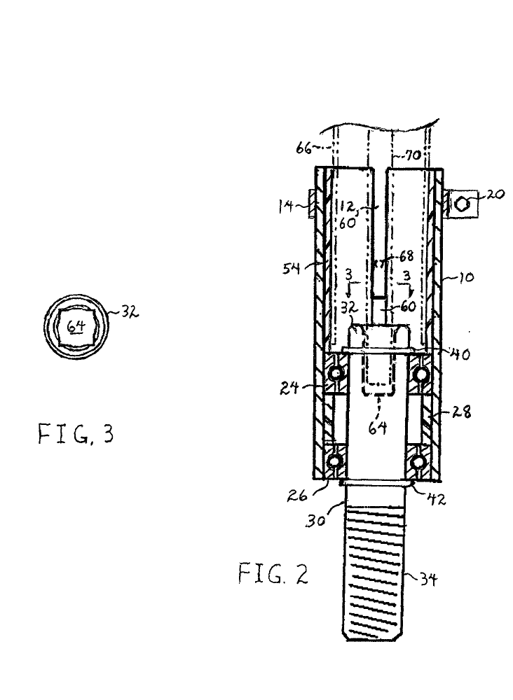

Arbor 30 is shown as being split into two parts for convenience of illustration, and has a socket end portion 32 and an opposing threaded end portion 34. Arbor 30 also has longitudinally spaced annular grooves 36 and 38 for receiving respective snap rings 40 and 42. Snap rings 40 and 42 function as safety “keepers”, as will be more apparent in FIG. 2. Threaded end portion 34 is capable of threadedly receiving threreon a rotary tool 44 having a threaded arbor hole 46 sized to receive the threaded end portion. The rotary tool illustrated in FIG. 1 is a cup brush. To assist in securing rotary tool 44 to threaded end portion 34, a “jam” nut 48 is typically provided to thread upon end portion 34 above the rotary tool so that the tool can be tightened against nut 48. Optionally, a washer 50 can be interposed between rotary tool 44 and nut 48 to act as a shim to prevent excessive protrusion of threaded end portion 34 through arbor hole 46, which could cause damage to a work piece against which the rotary tool is applied. Finally with regard to FIG. 1, any one of three bushings 52, 54, and 56 can be received within housing 10 adjacent to its upper end. Each bushing has a different inside diameter so as to make the rotary tool adapter essentially universal, as will be explained further below. Bushings 52, 54, and 56 also have respective slots 58, 60, and 62 longitudinally extending along their entire lengths.

Referring to FIG. 2, which shows the fully assembled rotary tool adapter in cross section (except for the arbor and snap rings), bearings 24 and 26 are press fit within housing 10 such that their outer races are fixed with respect to the housing. Spacer 28 is positioned between and in abutment with the outer races of longitudinally spaced bearings 24 and 26, with bearing 26 at the lower end of the housing. Arbor 30 is received through and press fit within the inner races of bearings 24 and 26 so that such inner races are fixed with respect to the arbor. Snap rings 40 and 42, as fixed upon arbor 30, are in snug contact with the inner races as shown to prevent any possible longitudinal movement of the arbor relative to bearings 24 and 26. Ball elements are also shown between the inner and outer races of the bearings. AS should be apparent, arbor 30 is coaxially rotatable with respect to housing 10. Arbor 30 extends from socket end portion 32 within housing 10 to threaded portion 34 outside the housing but adjacent to the lower end thereof. Socket end portion 32 has a substantially squared opening 64 defined therein, indicated by broken lines in FIG. 2. The shape of opening 64 is more clearly shown in the view of FIG. 3. The sides of squared opening 64 are slightly rounded simply because of the machining process for forming the opening, which involves drilling a round hole followed by broaching to form the square corners.

Continuing to refer to FIG. 2, the upper end of housing 10 is receivable over the lower end of a wand 66 (shown by phantom lines in cross section) such that a portion of the wand adjacent to its lower end extends at least partially into the housing. The lower end of wand 66 is shown in FIG. 2 as being spaced slightly above bearing 24. Of course, if wand 66 is the wand of a weed and grass trimmer, the cutter head has been previously removed from the lower end portion of the wand shown in FIG. 2. Since wand 66 in the illustrated embodiment has an outside diameter less than the inside diameter of housing 10 and the inside diameter of bushing 54 closely approximates the outside diameter of wand 66, bushing 54 is positioned snugly within housing 10 to receive the illustrated lower end portion of wand 66 therethrough. As shown, bushing 54 is of a length to extend from a lower end at bearing 24 to an upper end flush with the upper end of housing 10. Furthermore, bushing 54 is positioned within housing 10 so that slot 60 (of which a lowermost portion is not visible because of arbor 30) is aligned with one slot 12 of housing 10. Slots 12 and 60 are additionally aligned with a hole 68 in wand 66 adjacent to its lower end. Hole 68, as discussed further below, is commonly provided in the wands of most weed and grass trimmers. FIG. 2 further shows drive shaft 70 (in phantom lines) coaxially extending through wand 66. Drive shaft 70 has a squared lower end portion, adjacent to but protruding slightly beyond the lower end of wand 66, for being matingly and drivingly received in squared opening 64.

Clamp 14 is shown in FIG. 2 as removably engaging the exterior of housing 10 adjacent its upper end to thereby secure the housing to wand 66 by means of bolt 20 and associated nut 22 (FIG. 1). Slots 12 of housing 10 and slot 60 of bushing 54 allow for some flexibility and thus compression of the housing and bushing that may occur when tightening bolt 20 to securely clamp housing 10 to wand 66. Although clamp 14 will typically secure housing 10 to wand 66 adequately, hole 68 and aligned slots 12 and 60 can receive a small set screw (not shown) therethrough to assist in preventing the possible rotation of housing 10, as well as bushing 54, with respect to wand 66 because of the torque created by rotation of arbor 30 (i.e. 6,000-7,000 RPM). Hole 68 is used for a similar purpose in preventing possible rotation of a cutter head when attached to the wand. Slots 12 and 60 preferably have a width slightly larger than the diameter of any set screw received through hole 68, to thereby minimize any interference with the above-mentioned compression effect.

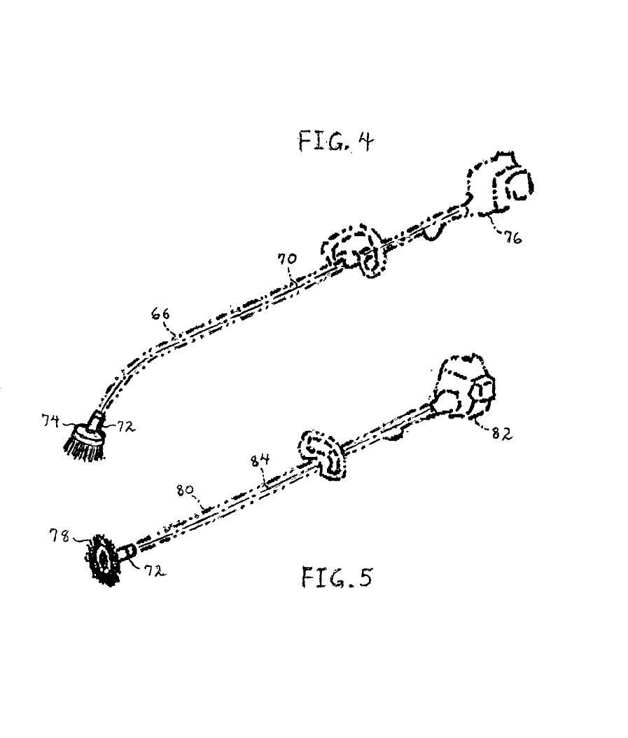

FIG. 4 shows the rotary tool adapter, as indicated at 72, and an associated cup brush 74 as connected to the lower end of wand 66, and a power head 76 connected to the upper end of wand 66. Power head 76 typically includes an internal combustion engine or other suitable power source for rotating drive shaft 70, which extends from the power head through wand 66 to adapter 72 for rotatably driving cup brush 74 in the manner described above. Wand 66 has a curved portion which requires that drive shaft 70 be flexible, such as in the form of a cable. FIG. 5 shows rotary tool adapter 72 and an associated wheel brush 78 as connected to the lower end of a straight wand 80. Similarly to FIG. 4, power head 82 is connected to the upper end of wand 80, and a drive shaft 84 extends from the power head through the wand to adapter 72 for rotatably driving wheel brush 78. In both FIGS. 4 and 5, the wands, drive shafts, and power heads are shown in phantom lines.

With regard to particularly preferred details of construction for the rotary tool adapter, housing 10 and arbor 30 are preferably comprised of a high quality, low carbon steel, and the wall thickness of the housing should be sufficient to make it very rigid for optimum durability and minimum vibration during use. The bushings and spacer 28 can be comprised of any suitably sturdy material, including plastic. Clamp 14 can be any appropriately strong but somewhat flexible metallic material. Some preferred dimensions will now be given only by way of example, and should not be construed to limit the invention in any manner: length of housing 10-3 inches; inside diameter of housing 10-1 inch; width of slots 12-5/32 inch; length of arbor 30-3 inches; corner to corner dimension along one side of opening 64-7/32 inch; inside diameter of bushing 52-25 mm; inside diameter of bushing 54-15/16 inch; inside diameter of bushing 56-7/8 inch. The dimensions given are approximate in the sense of being rounded to the nearest fraction or whole unit of measurement. For example, the inside diameters of housing 10 and the three bushings are slightly larger than indicated (by several hundredths of an inch) so as to provide a tight fit of close tolerance for corresponding wands of commercially available weed and grass trimmers having respective outside diameters of 1 inch, 25 mm, 15/16 inch, and 7/8 inch. The size of opening 64 is adapted to receive the 3/16 inch squared end portion that is standard to drive shafts of commercially available weed and grass trimmers. Therefore, the rotary tool adapter of the preferred embodiment is essentially universal with respect to commercial weed and grass trimmers once the cutter head is removed from the wand. The diameter of arbor 30 and the thread pitch of threaded portion 34 can be selected to be useable with rotary tools having a commonly available arbor hole, such as the metric M10×1.25.

Obviously, many modifications and variations of the present invention are possible in light of the above teachings. It is, therefore, to be understood that within the scope of the appended claims, the invention can be practiced otherwise than as specifically described.

That which is claimed is:

1. A rotary tool adapter for an apparatus of the type having a tubular wand with opposing first and second ends, a power head connected to the first wand end, and a drive shaft rotatable by and extending from the power head through the wand to a shaft end portion adjacent to the second wand end, wherein the adapter comprises:
a tubular housing having opposing first and second free ends, the first housing end being receivable over the second wand end such that a portion of the wand adjacent to the second wand end extends at least partially into the housing;
a means for removably securing the housing to the wand;
a substantially annular bearing means mounted within the housing; and
an arbor having a socket end portion and an opposing threaded end portion, the arbor being received through and mounted in the bearing means so as to be coaxially rotatable with respect to the housing and extend from the socket end portion within the housing to the threaded end portion outside the housing but adjacent to the second housing end, wherein the socket end portion is adapted to drivingly mate with the shaft end portion and the threaded end portion is capable of threadedly receiving thereon a rotary tool having a threaded arbor hole sized to receive the threaded end portion.

2. A rotary tool adapter as recited in claim 1 wherein the housing has at least one slot longitudinally extending from the first housing end.

3. A rotary tool adapter as recited in claim 2 wherein the housing has an exterior, and wherein the securing means includes a clamp for removably engaging the exterior of the housing adjacent to its first end.

4. A rotary tool adapter as recited in claim 3 wherein the bearing means includes at least one ball bearing.

5. A rotary tool adapter as recited in claim 4 wherein the bearing means includes a pair of longitudinally spaced ball bearings.

6. A rotary tool adapter as recited in claim 5 wherein the socket end portion has a substantially squared opening defined therein for matingly receiving the shaft end portion.

7. A rotary tool adapter as recited in claim 6 further comprising a bushing receivable within the housing adjacent to the first housing end, the bushing being sized to receive therethrough said portion of the wand adjacent to the second wand end.

8. A rotary tool adpater as recited in claim 7 wherein the bushing has a longitudinally extending slot.
